(19) United States
(12) Patent Application Publication
(10) Pub. No.: US 2025/0054165 A1
(43) Pub. Date: Feb. 13, 2025

(54) TECHNIQUES FOR LOW-LIGHT IMAGING

(71) Applicant: BAE SYSTEMS Imaging Solutions Inc., San Jose, CA (US)

(72) Inventors: Stephen W. Mims, San Diego, CA (US); Paul G. Lim, San Jose, CA (US)

(73) Assignee: BAE SYSTEMS Imaging Solutions Inc., San Jose, CA (US)

(21) Appl. No.: 18/448,452

(22) Filed: Aug. 11, 2023

(51) Int. Cl. G06T 7/246; G06T 5/00; G06T 5/20; G06T 7/60; G06V 10/82

(52) U.S. Cl. CPC G06T 7/248; G06T 5/20; G06T 5/70; G06T 7/60; G06V 10/82; G06T 2207/20084

(57) ABSTRACT

In one example, a method of image processing includes acquiring a plurality of input image frames, detecting at least one object of interest in individual image frames of the plurality of image frames, for the individual image frames, producing a respective bounding box corresponding to the at least one object of interest, the bounding box describing coordinates of a boundary of the object of interest within a respective individual image frame, temporally averaging corresponding pixel values of pixels within the bounding box over the plurality of image frames to produce a plurality of averaged pixel values, and producing an output image in which pixels within an area of the output image described by coordinates of the bounding box are replaced with the averaged pixel values.

### BACKGROUND

There are numerous applications, such as night-vision or astrophotography applications, for example, in which images of a viewed scene are acquired under low light conditions (e.g., incoming light levels in a range of 1-10 milli-Lux). In such conditions, the signal-to-noise ratio can be very low, making it challenging to image objects with any clarity. Some applications use an image intensifier, such as a photomultiplier, or single-photon avalanche diode (SPAD) detectors to increase the signal. However, these techniques cannot always provide sufficient compensation for the lack of illumination in very low light conditions to achieve an image with suitable clarity. Thus, a number of non-trivial issues remain with respect to imaging in low light conditions.

### SUMMARY

Aspects and embodiments are directed to techniques for improving the signal-to-noise ratio in low-light imaging applications using object detection and tracking over multiple image frames.

According to one embodiment, a method of image processing comprises acquiring a plurality of input image frames, detecting at least one object of interest in individual image frames of the plurality of image frames, for the individual image frames, producing a respective bounding box corresponding to each detected object of interest, the bounding boxes describing coordinates of the boundary of each object of interest within a respective individual image frame, temporally averaging corresponding pixel values of pixels within these bounding boxes over the plurality of image frames to produce a plurality of averaged pixel values, and producing an output image in which pixels within an area of the output image described by coordinates of the bounding boxes are replaced with the averaged pixel values.

Another embodiment, is directed to a computer program product including one or more non-transitory machine-readable mediums having instructions encoded thereon that when executed by at least one processor cause an image processing method to be carried out, the method comprising acquiring a plurality of input image frames, detecting at least one object of interest in individual image frames of the plurality of image frames, for the individual image frames, producing a respective bounding box corresponding to the at least one object of interest, the bounding box describing coordinates of a boundary of the object of interest within a respective individual image frame, temporally averaging corresponding pixel values of pixels within the bounding box over the plurality of image frames to produce a plurality of averaged pixel values, and producing an output image in which pixels within an area of the output image described by coordinates of the bounding box are replaced with the averaged pixel values.

According to another embodiment, an image sensor comprises an imaging device configured to acquire a temporal series of image frames, and a digital signal processing module coupled to the imaging device. The digital signal processing module is configured to process the image frames to detect at least one object of interest in individual image frames of the image frames, for the individual image frames, produce a respective bounding box corresponding to the at least one object of interest, the bounding box describing coordinates of a boundary of the object of interest within a respective individual image frame, average corresponding pixel values of pixels within the bounding box over the temporal series of image frames to produce a plurality of averaged pixel values, and produce an output image in which at least some pixels within an area of the output image described by coordinates of the bounding box are replaced with the averaged pixel values.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

In the figures:

FIG. 1 is a block diagram of one example of an image sensor in accord with aspects of the disclosed technology;

FIG. 2 is a diagram of one example of an image frame, showing an object of interest and a bounding box in accord with aspects of the disclosed technology;

FIG. 3 is a flow diagram of one example of an image processing methodology in accord with aspects of the disclosed technology; and

FIG. 4 is a block diagram of one example of a computing platform in accord with aspects of the disclosed technology.

### DETAILED DESCRIPTION

Techniques are disclosed for improving image quality and clarity in imaging applications operating in very low light conditions (e.g., incoming light levels below 200 micro-Lux, e.g., in a range of about 100-200 uLux). In one example, a method of image processing comprises acquiring a plurality of input image frames and detecting at least one object of interest in individual image frames of the plurality of image frames. For the individual image frames, a respective bounding box can be produced corresponding to each detected object of interest, wherein each bounding box describes coordinates of the boundary of the corresponding object of interest within a respective individual image frame. According to certain examples, for each detected object of interest, the method further includes temporally averaging corresponding pixel values of pixels within the bounding box over the plurality of image frames to produce a plurality of averaged pixel values, and producing an output image in which pixels within an area of the output image described by coordinates of the bounding box are replaced with the averaged pixel values. In this manner, the signal-to-noise ratio for object(s) of interest can be significantly improved (e.g., by 10× in some examples).

### General Overview

There is a need for the ability to image objects with reasonable clarity under very low light conditions. However, in some very low light applications, the signal-to-noise ratio (SNR) for objects in a given image frame can be less than 1 dB. This makes it very difficult to observe objects with any clarity, particularly when capturing images at high frame rates, such as in a range of about 45-100 frames per second (fps). For example, when capturing image frames at 90 fps in 100 micro-Lux (uLux) light, the SNR for a sensor with 0.5 electrons read noise might be less than 0.5 dB. Thus, in these conditions, the signal can be lost in the noise and any resulting image would be poor quality. As discussed above, one approach to addressing this problem is to attempt to increase the signal strength through the use of photomultipliers or single-photon avalanche diodes (SPADs). However, this approach has various drawbacks and cannot always achieve sufficient improvement in the SNR for some applications. Another approach involves using active illumination of objects of interest to increase the available light for imaging. However, this approach is not suitable for covert or other applications in which it is not desirable to identify the presence and/or location of the illuminator. Another approach involves the use of spatial filters on each image frame to average groups of nearby pixels in order to reduce noise. The drawback to this approach is the reduction in resolution, as represented by the modulation transfer function (MTF), that accompanies spatial averaging. Thus, a number of challenges remain with respect to imaging in very low light conditions.

Accordingly, techniques are disclosed herein for increasing the SNR for targeted objects of interest within an image frame, without incurring the MTF reduction associated with spatial averaging, thereby improving the ability to perform imaging in very low light conditions. According to certain examples, an object detection process is used to detect objects of interest within image frames, and to define one or more boundaries (referred to herein as bounding boxes) around the objects of interest. These objects can be tracked over multiple image frames. According to certain examples, pixels within the bounding boxes are temporarily averaged over multiple image frames, and the corresponding pixels in one or more of the image frames are replaced with the averaged value. In this manner, the SNR for the tracked objects/regions of interest can be increased. The length of averaging (e.g., the number of frames over which an object is tracked and the corresponding pixels are averaged) can be dynamically tuned to adjust to different conditions and/or different speeds of movement for moving objects of interest. In addition, in some examples, the bounding areas of tracked objects are highlighted in output image frames for case of observation by a user.

### System Architecture

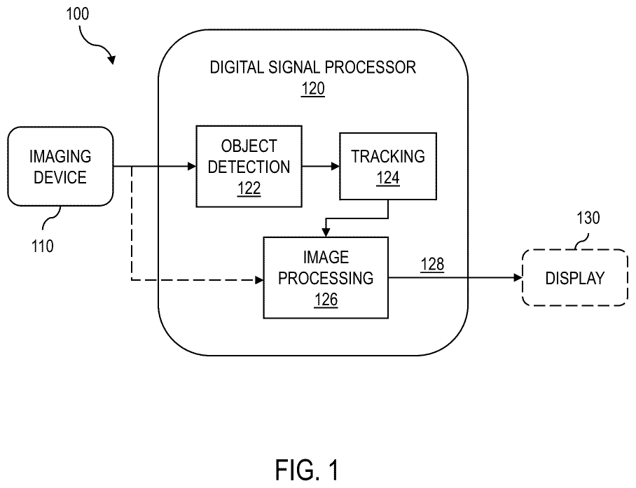

FIG. 1 is a block diagram of an example of an image sensor 100, according to some embodiments. The image sensor 100 includes an imaging device 110 and a digital signal processor 120. The image sensor 100 may be optionally coupled to a display 130 for displaying output images, as discussed further below. The imaging device 110 may, for example, represent or be an integral part of a charge coupled device (CCD) camera or other type of imaging device. In some embodiments, the imaging device 110 may be configured for capturing different portions of the electromagnetic spectrum, such as visible light, ultraviolet radiation, infrared radiation, or x-rays, to name a few examples. The imaging device 110 captures input images (of a viewed scene) that are provided to the digital signal processor 120 for processing, as described in more detail below. The imaging device 110 may be configured to capture images at a frame rate in a range of 45-90 frames per second in some examples, although any frame rate suitable for a given application can be used. The imaging device may be configured to operate in conditions of low incoming light, such as incoming light levels below 200 μLux, for example, in a range of about 100-200 μLux. More generally, any number of low light applications can benefit from the techniques provided herein, including night-vision, dark room, and astrophotography applications. As used herein, very low light refers to incoming light levels below 200 μLux, such as in a range of about 100-200 μLux, for example.

The imaging device 110 includes may include various components such as, for example, an array of photo-sensitive pixels, one or more column or row readout amplifiers, and one or more analog-to-digital converters (ADCs). In some examples, the imaging device 110 includes a processor that performs some image processing on the input image frames before they are provided to the digital signal processor 120. In other examples, the digital signal processor 120 receives raw input image data from the imaging device 110. In some examples, the imaging device 110 and the digital signal processor 120 are included together on same printed circuit board (PCB) or together in a single chip package (e.g., a system-in-package or system-on-chip). In some other embodiments, the imaging device 110 and the digital signal processor 120 may be provided in separate chip packages and/or on separate PCBs.

The digital signal processor 120 may be configured to receive the input image frames (which may be in the form of digitized signal data) from the imaging device 110 and perform any number of operations on the signal data. In examples in which the imaging device 110 does not include an onboard processor, the digital signal processor 120 may receive the signal data from the imaging device 110 and use the signal data to create an image or a portion of an image captured via the imaging device 110. Accordingly, while various examples herein describe the digital signal processor 120 as operating on input image frames received from the imaging device 110, it will be appreciated that in certain examples, the digital signal processor 120 may receive digital signal data from the imaging device 110, produce the input image frames from the digital signal data, and perform further processing on the input image frames. As used herein, the term “processor” may refer to any device or portion of a device that processes electronic data from registers and/or memory to transform that electronic data into other electronic data that may be stored in registers and/or memory. The digital signal processor 120 may include one or more application-specific integrated circuits (ASICs), central processing units (CPUs), graphics processing units (GPUS), server processors, custom-built semiconductor, or any other suitable processing devices.

According to certain examples, the digital signal processor 120 includes functional subsystems for object detection 122, tracking 124 of one or more detected objects of interest, and image processing 126. The functional subsystems 122, 124, 126 may be implemented in software, firmware, hardware, or any combination thereof. Further, any two or more of the functional subsystems 122, 124, 126 may be combined in implementation. Accordingly, the functional subsystems 122, 124, 126 are not necessarily intended to represent dedicated or discrete systems, but rather to represent functionality that may be implemented by the digital signal processor 120. Based on the input image frames and various processing functions described below, the digital signal processor 120 produces as output 128 one or more output image frames, which may be optionally displayed on the display 130, stored on a computer-readable storage medium, and/or provided to other electronics or devices.

As discussed above, the digital signal processor 120, through the object detection subsystem 122, is configured to detect one or more objects of interest in an input image frame. The image sensor 100 can use any of a variety of techniques to locate and recognize objects in an image frame, including computer vision based approaches and/or machine learning based approaches. According to certain examples, the object detection subsystem 122 can be implemented using an artificial neural network (ANN) that is trained to identify one or more types of objects of interest. The ANN may be implemented in software, hardware, or a combination of both. The ANN may be configured to perform any of various known methods of identifying objects in images.

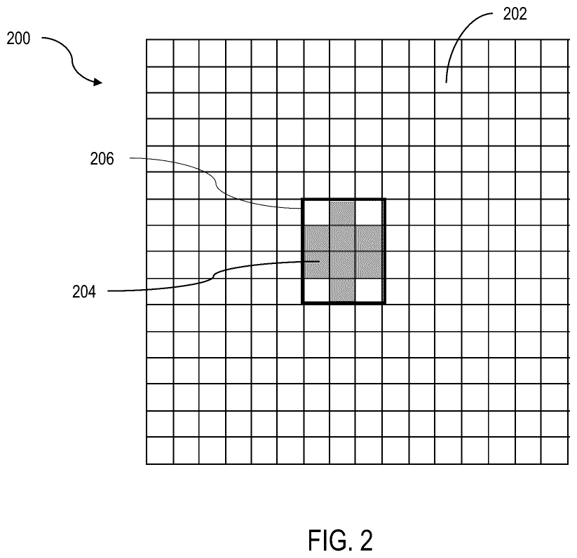

In one example, the object detection subsystem 122 is configured to implement an example of the YOLO (“you only look once”) object detection algorithm. The YOLO algorithm can be configured using one or more convolutional neural networks, and is capable of detecting objects with high detection accuracy even at fast imaging frame rates (e.g., 45 fps or higher). In such implementations, the object detection subsystem 122 produces as an output, one or more bounding boxes corresponding to one or more detected objects in a given image frame. Each bounding box corresponds to outlines or boundaries surrounding the pixels in the image frame that correspond to the respective detected object. An example is illustrated in FIG. 2. In some examples, each bounding box is described by a center point, a width, and a height. In some examples, the object detection subsystem 122 may produce “oriented” bounding boxes, which may not be square to the image frame axes. Accordingly, in which examples, the parameters describing each oriented bounding box further include a rotational angle (relative to one of the frame axes) as well as the center point and one or more sizing parameters (such as width, length, height, etc.). In another example, each bounding box can be described by four perimeter vertices. The parameters used to describe the bounding boxes may vary depending on the object detection algorithm applied by the object detection subsystem and/or the shape of the bounding box. For example, a circular bounding box may be described by a center point and a radius. Other variations will be appreciated given the benefit of this disclosure.

Referring to FIG. 2, there is illustrated a diagrammatic representation of an image frame 200. The image frame 200 includes a plurality of pixels 202 arranged in rows and columns to form a grid. In this example, an object 204 is identified by the object detection subsystem 122 in the image frame 200. The object detection subsystem 122 produces a bounding box 206 that surrounds the pixels 202 corresponding to the detected object 204. Thus, the bounding box 206 describes where in the image frame the detected object 204 is located. In the example illustrated in FIG. 2, the bounding box 206 is rectangular; however, in other examples the bounding box may be a polygon, triangle, or circle, or may have some other shape, depending on the object detection bounding box algorithm employed. To this end, note that object 204 does not have to completely fill bounding box 206. For instance, if using a YOLO-based object detection algorithm, top, bottom and opposing sides of bounding box 206 may touch one or more points along corresponding edges of object 204, such as shown in the example of FIG. 2. Other object detection algorithms may be more conformal to the given shape and perimeter of object 204, while still other object detection algorithms may include more buffer space between sides of bounding box 206 and the perimeter of object 204. However, note that reducing buffer space between sides of bounding box 206 and the perimeter of object 204 may increase accuracy of subsequent pixel averaging, as further described below.

Referring again to FIG. 1, the tracking subsystem 124 may be configured to track one or more objects of interest detected by the object detection subsystem 122 over multiple image frames. In certain examples, the tracking subsystem employs a Kalman filter or other digital filtering technique to track the bounding boxes 206 associated with the detected object(s) of interest 204. The number of image frames used for averaging can be a predetermined number, which may be fixed or variable, or can be based on a particular boundary box continuing to be present in multiple processed image frames, optionally up until a predetermined limit number of image frames have been processed. For example, once an object is detected by the object detection subsystem 122 and its bounding box is created, the tracking subsystem 124 may continue to aggregate image frames in which the bounding box is identified until such time as the object is no longer detected by the object detection subsystem 122 (no corresponding bounding box is produced for the that frame) or until the limit number is reached.

In some examples, the tracking subsystem 124 stores, or causes to be stored, a number of consecutive image frames with overlapping/corresponding bounding boxes (sometimes called boundary boxes), such that values of the pixels within the boundary boxes can be averaged by the image processing subsystem 126 as described further below. In other examples, for each detected object of interest, the tracking subsystem 124 stores, or causes to be stored, an array of pixels that is larger in extent than the initial corresponding bounding box of the detected object by a selected amount. For example, the stored array of pixels may be 15%, 20%, 25%, or some other percentage value larger in extent than initial corresponding bounding box of the detected object. The additional size of the stored array of pixels may account for potential variations in the size and/or position of the bounding box from frame to frame. In some examples, a third dimension of this stored array of pixels is also stored, with the third dimension corresponding to the temporal values of the pixels over a past number of image frames. In some examples, the past number of image frames corresponds to the number of image frames to be used for averaging, such as the past 100 frames, for example. Arrays can be stored for each detected object of interest and its associated bounding box. The arrays can be updated as image frames are acquired and processed by the object detection subsystem 122 and the tracking subsystem 124. In some examples, the area sum of the bounding boxes associated with each detected object of interest within a given image frame may be significantly smaller than the full-sized image frame. Accordingly, storing arrays corresponding to each boundary box/detected object, as described above, may consume less storage space than storing full-size image frames. However, as noted above, in some examples the full-sized image frames can be stored and processed.

Based on a collected set of image frames (or on a stored array containing information derived from the collected set of image frames) corresponding to a tracked object, the image processing subsystem 126 averages the pixel values for those pixels within a given boundary box 206 (and therefore corresponding to a particular object of interest 204). In an output image frame containing the object of interest, the pixels within the corresponding bounding box are replaced with the averaged values, while leaving the remainder of the image unchanged. In some examples, this process can significantly improve the SNR for the tracked object, for example, by 10 times or more. For example, with incoming light at 107.6 μLux (equivalent to overcast starlight), the photon flux density at a 10 μm pixel, for light at a particular wavelength, such as 540 nm, for example, is approximately 41 photons per pixel per second. An example of the imaging device 110 may include pixels with a pixel quantum efficiency of 0.81 at 540 nm. Accordingly, for such an imaging device 110 operated at an image capture rate of 90 fps, the mean signal level may be approximately 0.37 e−. With an electrical read noise of 0.5 e− at that frame rate, a dark current of 16 e− per pixel per second (estimated for an operating temperature of 40 degrees Celsius), and signal shot noise, the total noise is estimated to be approximately 0.89 e−, for an SNR of 0.41 dB. Applying the object detection, tracking, and pixel averaging processes described above, using 100 frames for averaging, the SNR may be increased to about 4.1 dB (10× improvement). Decreasing the incoming light level to 10.76 μLux drops the SNR to 0.05 dB; however, the process disclosed herein can increase the SNR back to 0.5 dB, for example, using 100-frame averaging.

As described above, the number of image frames used for the averaging process can be a predetermined number, e.g., 10, 100, 150, etc., that can be selected based on any of a number of factors. In some examples, the number may be based on the image capture frame rate of the imaging device 110 and/or the incoming light levels. In some examples, the system can be configured such that the number of image frames used for averaging is a fixed number. In other examples, the number of image frames used for averaging may be a programmable parameter that can be adjusted by a user of the image sensor 100. In some examples, the number of image frames used for averaging may depend on the number of image frames that the tracking subsystem 124 associates in a set with a given tracked object, as described above. In other examples, the tracking subsystem 124 and the image processing subsystem 126 may be configured to obtain a set or batch of image frames that includes a predetermined number of frames; however, the image processing subsystem 126 can be configured to apply the averaging only over those image frames within the batch in which at least one tracked object of interest has been detected, and the corresponding bounding boxes therefore exist. In this manner, the system can be configured to “ignore” image frames in which the object of interest is not detected.

It will be appreciated, given the benefit of this disclosure, that any mismatch in the bounding box coordinates from frame to frame may result in a lower MTF (smearing) through temporal averaging of non-corresponding object elements. Accordingly, in some examples, the imaging processing subsystem 126 is configured to apply a weighting parameter that helps to “smooth out” any movement of the object bounding box caused by random error. For example, as described above, in some instances the bounding boxes are identified by a center point, along with a width and a height, or other size-determining parameter(s) (such as a radius, for example), and optionally a rotational angle. Accordingly, in some examples, movement of the center point from frame to frame can be constrained by a weighting factor based on the position of the center point in a previous image frame and, optionally, velocity seen in previous image frames. In one example, the center point of the bounding box in the current image frame can be set to the average of the current position combined with a weighting of the center point position(s) from one or more prior image frames. It will be appreciated that various alternate approaches or variations may be applied in other examples.

According to certain examples, since the bounding box coordinates are used to process the SNR improvement through temporal pixel averaging over multiple image frames, spatial (or other) filtering on each image may be done before applying the object detection process in order to obtain more precise boundary coordinates. In one example, spatial filtering may be performed by averaging adjacent (or nearby) pixel values within an image frame (referred to as spatial averaging) before the image frame is processed using the object detection algorithm. For example, applying a two pixel by two pixel (2×2) averaging filter over an image frame may smooth away some temporal noise even though all the pixels are imaged at approximately the same time by the imaging device 110. Spatial averaging has been shown to increase SNR. Therefore, applying spatial filtering to individual image frames can assist the object detection algorithm in accurately detecting objects of interest and producing the corresponding bounding boxes. Thus, according to some examples, an image frame can be enhanced with spatial (or other) filtering before it is processed by the object detection subsystem 122. Once the object detection subsystem 122 identifies the bounding box coordinates based on the enhanced image frame, those bounding coordinates can be used on the original image frame to effect the SNR improvement through temporal averaging (by the image processing subsystem 126), as described above. In this manner, spatial filtering can be leveraged to improve object detection accuracy without the MTF reduction that can occurs when attempting to use spatial filtering for SNR improvement.

As described above, in some examples, the output image frame 128 produced by the image processing subsystem 126, which includes improved SNR for the region of the image corresponding to the object(s) of interest, can be provided for display on the display 130. In some examples, individual bounding boxes associated with one or more objects of interest can be shown in the output image frame 128 on the display 130 to draw a user's attention to the object(s) of interest. The bounding boxes may be separately amplified (e.g., digitally) and/or highlighted (e.g., displayed in a particular bright color) for ease of observation by the user.

### Methodology

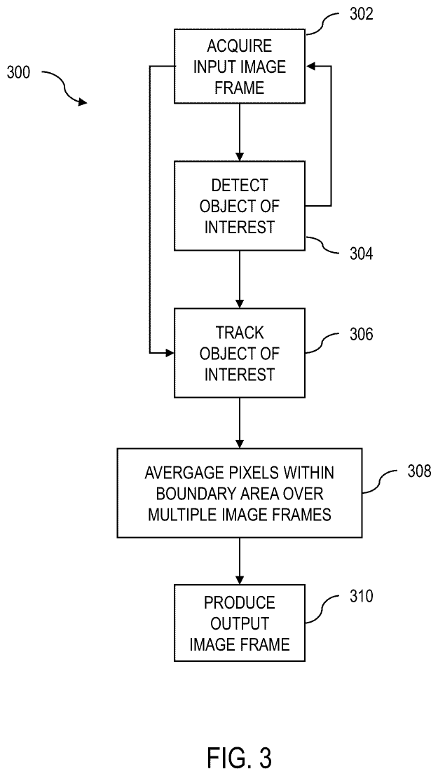

Referring to FIG. 3, there is depicted a process flow diagram of an example of a method 300 of image processing to achieve improved SNR, according to certain examples such as under very low light conditions.

At operation 302, one or more input image frames are acquired, for example, using the imaging device 110.

At operation 304, the input image frame(s) is/are processed, for example, using the digital signal processor 120, to detect one or more objects of interest. In examples, input image frames are processed individually at operation 304. When an object of interest is detected in an image frame, a bounding box corresponding to a boundary surrounding the object of interest is created, as described above. In certain examples, detection of the one or more objects of interest is performed by applying a YOLO object detection algorithm.

At operation 306, one or more bounding boxes produced at operation 304 are tracked over multiple image frames. Accordingly, operations 302 and/or 304 can be repeated, such that operation 306 produces a batch of image frames that include the bounding boxes corresponding to one or more objects of interest. As described above, in some examples, the batch of image frames may include a specified number of image frames, such as 100 frames, for example. The number of image frames can be varied depending on any of numerous factors, including the frame rate of the imaging device 110, light conditions, desired improvement factor in the SNR, or information regarding potential movement of one or more objects of interest, to name a few.

As also described above, in some examples, operations 304 and 306 include storing an array of pixels for each detected object/boundary box, along with an added dimension corresponding to the temporal values of the pixels over the set of image frames, and updating the stored arrays as new image frames are acquired and processed.

At operation 308, the pixels within a given bounding box are averaged over some or all of the image frames in the batch to thereby improve the SNR for the corresponding object of interest.

At operation 310, an output image 128 is produced. As described above, in the output image 128, the pixels within a particular bounding box are replaced with the averaged pixel values acquired at operation 308, while the remainder of the image may be left unchanged. As a result, the SNR in the output image 128 for the object of interest inside the bounding box may be substantially improved relative to the remainder of the image. This may have the effect of allowing objects of interest to be imaged with greater clarity. In addition, the bounding box can be displayed in the output image 128, to further draw a user's attention to the object of interest.

As described above, in some examples, the output images 128 produced at operation 310 can be displayed on the display 130, for example. In other examples, the output images can be stored on a computer readable medium and/or transferred to another electronic device or system for further processing and/or viewing.

### Example Computing Platform

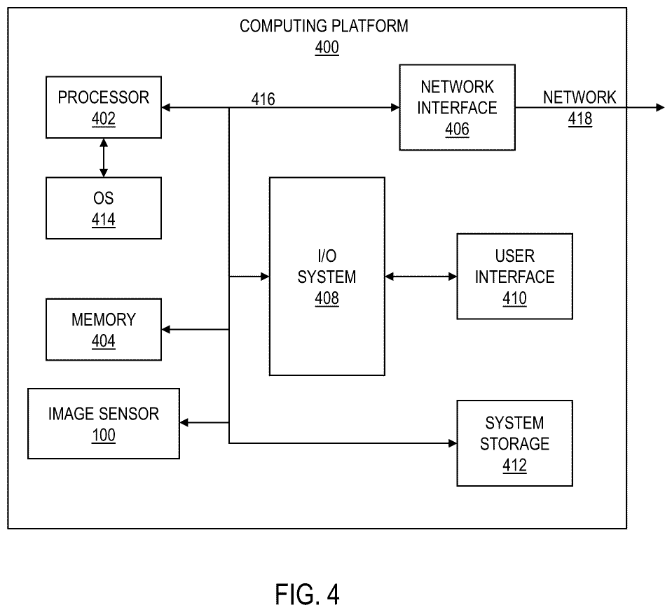

FIG. 4 illustrates an example computing platform 400 that can be used to implement components and/or functionality of the image sensor 100 described herein. In some embodiments, computing platform 400 may host, or otherwise be incorporated into a personal computer, workstation, server system, laptop computer, ultra-laptop computer, tablet, touchpad, portable computer, handheld computer, palmtop computer, personal digital assistant (PDA), cellular telephone, combination cellular telephone and PDA, smart device (for example, smartphone or smart tablet), mobile internet device (MID), messaging device, data communication device, imaging device, wearable device, embedded system, and so forth. Any combination of different devices may be used in certain embodiments. In some embodiments, the computing platform 400 represents one system in a network of systems coupled together via controlled area network (CAN) bus or other network bus.

In some examples, the computing platform 400 may comprise any combination of a processor 402, a memory 404, an embodiment of the image sensor 100 (or at least some components thereof), a network interface 406, an input/output (I/O) system 408, a user interface 410, and a storage system 412. In some embodiments, one or more components of the image sensor 100 (e.g., the digital signal processor or some functional subsystems thereof) are implemented as part of the processor 402. As shown in FIG. 4, a bus and/or interconnect 416 is also provided to allow for communication between the various components listed above and/or other components not shown. The computing platform 400 can be coupled to a network 418 through the network interface 406 to allow for communications with other computing devices, platforms, or resources. Other componentry and functionality not reflected in the block diagram of FIG. 4 will be apparent in light of this disclosure, and it will be appreciated that other embodiments are not limited to any particular hardware configuration.

The processor 402 can be any suitable processor and may include one or more coprocessors or controllers to assist in control and processing operations associated with the computing platform 400. In some embodiments, the processor 402 may be implemented as any number of processor cores. The processor (or processor cores) may be any type of processor, such as, for example, a micro-processor, an embedded processor, a digital signal processor (DSP), a graphics processor (GPU), a network processor, a field programmable gate array or other device configured to execute code. The processors may be multithreaded cores in that they may include more than one hardware thread context (or “logical processor”) per core.

The memory 404 can be implemented using any suitable type of digital storage including, for example, flash memory and/or random access memory (RAM). In some embodiments, the memory 404 may include various layers of memory hierarchy and/or memory caches as are known to those of skill in the art. The memory 404 may be implemented as a volatile memory device such as, but not limited to, a RAM, dynamic RAM (DRAM), or static RAM (SRAM) device. The storage system 412 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device. In some embodiments, the storage system 412 may comprise technology to increase the storage performance enhanced protection for valuable digital media when multiple hard drives are included. The storage system 412 and/or the memory 404 may store image frames acquired by the imaging device 110 and/or processed by the digital signal processor 120. In some examples, the storage system 412 may store the pixel arrays corresponding to the boundary boxes associated with tracked objects of interest, as described above.

The processor 402 may be configured to execute an Operating System (OS) 414 which may comprise any suitable operating system, such as Google Android (Google Inc., Mountain View, CA), Microsoft Windows (Microsoft Corp., Redmond, WA), Apple OS X (Apple Inc., Cupertino, CA), Linux, or a real-time operating system (RTOS). As will be appreciated in light of this disclosure, the techniques provided herein can be implemented without regard to the particular operating system provided in conjunction with the computing platform 400, and therefore may also be implemented using any suitable existing or subsequently-developed platform.

The network interface 406 can be any appropriate network chip or chipset which allows for wired and/or wireless connection between other components of the computing platform 400 and/or the network 418, thereby enabling the computing platform 400 to communicate with other local and/or remote computing systems, servers, cloud-based servers, and/or other resources. In some examples, the network interface 406 may allow the computing platform to acquire the image frames from the imaging device 110, for example. Wired communication may conform to existing (or yet to be developed) standards, such as, for example, Ethernet. Wireless communication may conform to existing (or yet to be developed) standards, such as, for example, cellular communications including LTE (Long Term Evolution), Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

The I/O system 408 may be configured to interface between various I/O devices and other components of the computing platform 400. I/O devices may include, but not be limited to, a user interface 410. The user interface 410 may include devices (not shown) such as a display element, touchpad, keyboard, mouse, and speaker, etc. The I/O system 408 may include a graphics subsystem configured to perform processing of images for rendering on a display element. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into the processor 402 or any chipset of the computing platform 400. In some examples, the I/O system 408 may include the display 130 to display the output image frame(s) 128 to a user.

It will be appreciated that in some embodiments, the various components of the computing platform 400 may be combined or integrated in a system-on-a-chip (SoC) architecture. In some embodiments, the components may be hardware components, firmware components, software components or any suitable combination of hardware, firmware or software.

In various embodiments, the computing platform 400 may be implemented as a wireless system, a wired system, or a combination of both. When implemented as a wireless system, the computing platform 400 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, the computing platform 400 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The embodiments are not limited in this context.

The terms “circuit” or “circuitry,” as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Other embodiments may be implemented as software executed by a programmable control device. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, GPUs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

### Additional Examples

Example 1 is a method of image processing, the method comprising acquiring a plurality of input image frames, detecting at least one object of interest in individual image frames of the plurality of image frames, for the individual image frames, producing a respective bounding box corresponding to the at least one object of interest, the bounding box describing coordinates of a boundary of the object of interest within a respective individual image frame, temporally averaging corresponding pixel values of pixels within the bounding box over the plurality of image frames to produce a plurality of averaged pixel values, and producing an output image in which pixels within an area of the output image described by coordinates of the bounding box are replaced with the averaged pixel values.
Example 2 includes the method of Example 1, wherein producing the bounding box includes determining a center point and at least one sizing parameter of the bounding box in a first image frame of the plurality of image frames, and constraining the center point of the bounding box in a second image frame of the plurality of image frames based at least in part on a weighting factor applied to the center point of the bounding box in the first image frame.
Example 3 includes the method of Example 2, wherein the at least one sizing parameter includes one or more of a width, a length, or a height.
Example 4 includes the method of any one of Examples 1-3, wherein producing the bounding box further includes determining a rotational angle of the bounding box in the first image frame.
Example 5 includes the method of any one of Examples 1-4, wherein detecting the at least one object of interest includes processing the individual image frames using one or more convolutional neural networks.
Example 6 includes the method of any one of Examples 1-5, wherein producing the output image includes producing the output image including the bounding box positioned around the at least one object of interest.
Example 7 includes the method of any one of Examples 1-6, wherein acquiring the plurality of input image frames includes accessing the plurality of input image frames from at least one non-transitory machine-readable storage medium.
Example 8 includes the method of any one of Examples 1-6, wherein acquiring the plurality of input image frames includes receiving the plurality of input image frames from an imaging device, wherein the individual image frames are acquired by the imaging device under very low light conditions, such as incoming light levels below 200 μLux, for example, or in a range of 100-200 μLux, for example.
Example 9 includes the method of any one of Examples 1-8, further comprising displaying the output image on a display.
Example 10 includes the method of any one of Examples 1-9, wherein detecting the at least one object of interest and producing the respective bounding box comprises applying a spatial averaging filter to the individual image frames to produce corresponding individual filtered image frames, determining the coordinates of the bounding box in a respective filtered image frame, and applying the bounding box to the respective individual image frame.
Example 11 includes a system configured to implement the method of any one of Examples 1-10.
Example 12 provides a computer program product including one or more non-transitory machine-readable mediums having instructions encoded thereon that when executed by at least one processor cause an image processing method to be carried out, the method comprising acquiring a plurality of input image frames, detecting at least one object of interest in individual image frames of the plurality of image frames, for the individual image frames, producing a respective bounding box corresponding to the at least one object of interest, the bounding box describing coordinates of a boundary of the object of interest within a respective individual image frame, temporally averaging corresponding pixel values of pixels within the bounding box over the plurality of image frames to produce a plurality of averaged pixel values, and producing an output image in which pixels within an area of the output image described by coordinates of the bounding box are replaced with the averaged pixel values.
Example 13 includes the computer program product of Example 12, wherein producing the bounding box includes determining a center point and at least one sizing parameter of the bounding box in a first image frame of the plurality of image frames, and constraining the center point of the bounding box in a second image frame of the plurality of image frames based at least in part on a weighting factor applied to the center point of the bounding box in the first image frame.
Example 14 includes the computer program product of Example 13, the at least one sizing parameter includes one or more of a width, a length, or a height.
Example 15 includes the computer program product of one of Examples 13 and 14, wherein producing the bounding box further includes determining a rotational angle of the bounding box in the first image frame.
Example 16 includes the computer program product of any one of Examples 12-15, wherein detecting the at least one object of interest includes processing the individual image frames using one or more convolutional neural networks.
Example 17 includes the computer program product of any one of Examples 12-16, wherein producing the output image includes producing the output image including the bounding box positioned around the at least one object of interest.
Example 18 includes the computer program product of any one of Examples 12-17, wherein acquiring the plurality of input image frames includes accessing the plurality of input image frames from at least one non-transitory machine-readable storage medium.
Example 19 is an image sensor comprising an imaging device configured to acquire a temporal series of image frames, and a digital signal processing module coupled to the imaging device. The digital signal processing module is configured to process the image frames to detect at least one object of interest in individual image frames of the image frames, for the individual image frames, produce a respective bounding box corresponding to the at least one object of interest, the bounding box describing coordinates of a boundary of the object of interest within a respective individual image frame, average corresponding pixel values of pixels within the bounding box over the temporal series of image frames to produce a plurality of averaged pixel values, and produce an output image in which at least some pixels within an area of the output image described by coordinates of the bounding box are replaced with the averaged pixel values.
Example 20 includes the image sensor of Example 19, wherein to produce the bounding box, the digital signal processing module is configured to determine a center point and at least one sizing parameter of the bounding box in a first image frame of the plurality of image frames, and constrain the center point of the bounding box in a second image frame of the plurality of image frames based at least in part on a weighting factor applied to the center point of the bounding box in the first image frame.
Example 21 includes the image sensor of Example 20, wherein the at least one sizing parameter includes one or more of a width, a length, or a height.
Example 22 includes the image sensor of one of Examples 20 and 21, wherein to produce the bounding box, the digital signal processing module is configured determine a rotational angle of the bounding box in the first image frame.
Example 23 includes the image sensor of any one of Examples 19-22, wherein to detect the at least one object of interest, the digital signal processing module is configured to process the individual image frames using one or more convolutional neural networks.
Example 24 includes the image sensor of any one of Examples 19-23, wherein to produce the output image, the digital signal processing module is configured to produce the output image including the bounding box positioned around the at least one object of interest.
Example 25 includes the image sensor of any one of Examples 19-24, further comprising a display coupled to the digital signal processing module and configured to display the output image.
Example 26 includes the image sensor of any one of Examples 19-25, wherein the imaging device is configured to acquire the image frames at a frame rate of between 45 and 90 frames per second.
Example 27 includes the image sensor of any one of Examples 19-26, wherein to detect the at least one object of interest and to produce the bounding box, the digital signal processing module is configured to apply a spatial averaging filter to the individual image frames to produce corresponding filtered image frames, determine the coordinates of the bounding box in a respective filtered image frame, and apply the bounding box to the respective individual image frame.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the claims. Accordingly, the foregoing description and drawings of various embodiments are presented by way of example only. These examples are not intended to be exhaustive or to limit implementation to the precise forms disclosed. The methods and apparatuses are capable of implementation in other embodiments and of being practiced or of being carried out in various ways. In addition, the phraseology and terminology used herein is for the purpose of description and should not be regarded as limiting. Any references to examples, components, elements, or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including”, “comprising”, “having”, “containing”, “involving”, and variations thereof is meant to encompass the items listed thereafter and equivalents thereof as well as additional items. References to “or” can be construed as inclusive so that any terms described using “or” can indicate any of a single, more than one, and all of the described terms.

What is claimed is:

1. A method of image processing, the method comprising:
acquiring a plurality of input image frames;
detecting at least one object of interest in individual image frames of the plurality of image frames;
for the individual image frames, producing a respective bounding box corresponding to the at least one object of interest, the bounding box describing coordinates of a boundary of the object of interest within a respective individual image frame;
temporally averaging corresponding pixel values of pixels within the bounding box over the plurality of image frames to produce a plurality of averaged pixel values; and
producing an output image in which pixels within an area of the output image described by coordinates of the bounding box are replaced with the averaged pixel values.

2. The method of claim 1, wherein producing the bounding box includes:
determining a center point and at least one sizing parameter of the bounding box in a first image frame of the plurality of image frames; and
constraining the center point of the bounding box in a second image frame of the plurality of image frames based at least in part on a weighting factor applied to the center point of the bounding box in the first image frame.

3. The method of claim 1, wherein detecting the at least one object of interest includes processing the individual image frames using one or more convolutional neural networks.

4. The method of claim 1, wherein producing the output image includes producing the output image including the bounding box positioned around the at least one object of interest.

5. The method of claim 1, wherein acquiring the plurality of input image frames includes accessing the plurality of input image frames from at least one non-transitory machine-readable storage medium.

6. The method of claim 1, wherein acquiring the plurality of input image frames includes receiving the plurality of input image frames from an imaging device, wherein the individual image frames are acquired by the imaging device under a very low light condition.

7. The method of claim 1, further comprising displaying the output image on a display.

8. The method of claim 1, wherein detecting the at least one object of interest and producing the respective bounding box comprises:
applying a spatial averaging filter to the individual image frames to produce corresponding individual filtered image frames;
determining the coordinates of the bounding box in a respective filtered image frame; and
applying the bounding box to the respective individual image frame.

9. A computer program product including one or more non-transitory machine-readable mediums having instructions encoded thereon that when executed by at least one processor cause an image processing method to be carried out, the method comprising:
acquiring a plurality of input image frames;
detecting at least one object of interest in individual image frames of the plurality of image frames;
for the individual image frames, producing a respective bounding box corresponding to the at least one object of interest, the bounding box describing coordinates of a boundary of the object of interest within a respective individual image frame;
temporally averaging corresponding pixel values of pixels within the bounding box over the plurality of image frames to produce a plurality of averaged pixel values; and
producing an output image in which pixels within an area of the output image described by coordinates of the bounding box are replaced with the averaged pixel values.

10. The computer program product of claim 9, wherein producing the bounding box includes:
determining a center point and at least one sizing parameter of the bounding box in a first image frame of the plurality of image frames; and
constraining the center point of the bounding box in a second image frame of the plurality of image frames based at least in part on a weighting factor applied to the center point of the bounding box in the first image frame.

11. The computer program product of claim 9, wherein detecting the at least one object of interest includes processing the individual image frames using one or more convolutional neural networks.

12. The computer program product of claim 9, wherein producing the output image includes producing the output image including the bounding box positioned around the at least one object of interest.

13. The computer program product of claim 9, wherein acquiring the plurality of input image frames includes accessing the plurality of input image frames from at least one non-transitory machine-readable storage medium.

14. An image sensor comprising:
an imaging device configured to acquire a temporal series of image frames; and
a digital signal processing module coupled to the imaging device and configured to
process the image frames to detect at least one object of interest in individual image frames of the image frames,
for the individual image frames, produce a respective bounding box corresponding to the at least one object of interest, the bounding box describing coordinates of a boundary of the object of interest within a respective individual image frame,
average corresponding pixel values of pixels within the bounding box over the temporal series of image frames to produce a plurality of averaged pixel values, and
produce an output image in which at least some pixels within an area of the output image described by coordinates of the bounding box are replaced with the averaged pixel values.

15. The image sensor of claim 14, wherein to produce the bounding box, the digital signal processing module is configured to:
determine a center point and at least one sizing parameter of the bounding box in a first image frame of the plurality of image frames; and
constrain the center point of the bounding box in a second image frame of the plurality of image frames based at least in part on a weighting factor applied to the center point of the bounding box in the first image frame.

16. The image sensor of claim 14, wherein to detect the at least one object of interest, the digital signal processing module is configured to process the individual image frames using one or more convolutional neural networks.

17. The image sensor of claim 14, wherein to produce the output image, the digital signal processing module is configured to produce the output image including the bounding box positioned around the at least one object of interest.

18. The image sensor of claim 14, further comprising a display coupled to the digital signal processing module and configured to display the output image.

19. The image sensor of claim 14, wherein the imaging device is configured to acquire the image frames at a frame rate of between 45 and 90 frames per second.

20. The image sensor of claim 14, wherein to detect the at least one object of interest and to produce the respective bounding box, the digital signal processing module is configured to:
apply a spatial averaging filter to the individual image frames to produce corresponding individual filtered image frames;
determine the coordinates of the bounding box in a respective filtered image frame; and
apply the bounding box to the respective individual image frame.
